(19) United States
(12) Patent Application Publication
(10) Pub. No.: US 2005/0118918 A1
(43) Pub. Date: Jun. 2, 2005

(54) Flame-resistant wadding material for clothing protecting against thermal effects

(76) Inventors: Werner Schafer, Birkenau (DE); Eberhard Link, Raleigh, NC (US); Hans Rettig, Heppenheim (DE)

Correspondence Address: KENYON & KENYON, ONE BROADWAY, NEW YORK, NY, 10004, US

(21) Appl. No.: 10/499,423

(22) PCT Filed: Jul. 27, 2002
(86) PCT No.: PCT/EP02/08400

(30) Foreign Application Priority Data
Dec. 21, 2001 (DE) 101 63 548.6

(51) Int. Cl. D04H 1/46; D04H 1/70; B32B 27/04; B27N 9/00; B32B 5/02

(52) U.S. Cl. 442/408; 428/920; 428/921; 428/219; 442/415; 442/416; 442/414; 442/136; 28/104

(57) ABSTRACT

A flame-resistant interlining fabric for protective clothing made of a nonwoven fabric bonded by high-pressure fluid jet treatment, having weights per unit area of 40 to 200 g/m² and containing 20 to 50 wt. % sheep wool and 50 to 80 wt. % of at least one synthetic, flame-retardant fiber.

### FIELD OF THE INVENTION

The present invention relates to a flame-resistant interlining fabric for protective clothing made of nonwoven fabrics bonded by high-pressure fluid jet treatment and having weights per unit area of 40 to 200 g/m².

### BACKGROUND OF THE INVENTION

Interlining fabrics in protective clothing are designed to protect the wearer against thermal exposure. For this reason, firefighter service garments, clothing protective against electric arc exposure such as protective clothing for high-voltage electricians, protective clothing for welders or race driver garments are equipped with suitable linings. In these applications, they act as a thermal insulating barrier against flame exposure or as protection against infrared radiation.

U.S. Pat. No. 5,534,325 describes water-jet-needled nonwoven fabrics made of synthetic, flame-retardant fibers additionally containing vermiculite. These nonwoven fabrics are used as a flame barrier especially in passenger aircraft seats. Although these materials are characterized by high thermal stability, good thermal insulating capacity as well as a very high flame resistance, they are not suitable for protective clothing due to their poor moisture-transport properties, their poor properties from the standpoint of clothing physiology and a consequently limited wear comfort.

GB 2 245 606 describes flame-resistant interlining fabrics which are made of nonwoven fabrics and in which wool fibers, acrylic fibers, aramide fibers, polyamide fibers, polybenzimidazole fibers or viscose fibers are mixed and thermally bonded by use of a binder or binding fibers following carding.

Furthermore, U.S. Pat. No. 4,849,280 describes a laminate for fire protective clothing which is composed of a first layer of unwoven fabric made of a mixture of wool and a fiber having high-temperature properties and a second woven layer made of wool and high-temperature resistant fibers. Information regarding the bonding technology and the weights per unit area as well as their haptic properties cannot be gathered from the document.

### SUMMARY OF THE INVENTION

It is the object of the present invention to specify a flame-resistant interlining fabric of the type mentioned at the outset, which fulfills all requirements of national and international standards as, for example, in the area of fire fighting (Herstellungs-und Prüfungsbeschreibung für eine universelle Feuerwehrschutzbekleidung [Manufacture and Testing Specifications for a Universal Firefighter Protective Garment] —HuPf, European Norm—EN 469, American standards—NFPA 1971 or AS 4967-2001) with regard to flame and heat resistance and dimensional stability following care treatment. In addition, the flame-resistant interlining fabrics are intended to exhibit greater wear comfort, a softer hand as well as good water-vapor-absorption capacity and moisture-transport properties.

### DETAILED DESCRIPTION

According to the present invention, the objective is achieved by a flame-resistant interlining fabric made of a nonwoven fabric bonded by high-pressure fluid jets, having weights per unit area of 40 to 100 g/m² and containing 20 to 50 wt. % sheep wool and 50 to 80 wt. % of at least one synthetic, flame-retardant fiber. The flame-resistant interlining fabric according to the present invention has an insulating capacity, determined by the TPP (Thermal Protection Performance) value according to the US standard NFPA 1971-2000, of 31 to 55 at thicknesses of 0.5 to 2.0 mm and a humidity-absorption capacity of 8 to 25%.

The flame-resistant interlining fabric according to the present invention advantageously has a weight per unit area of 50 to 100 g/m². In spite of this low weight per unit area, an insulating capacity comparable to hitherto known materials is achieved, which means that the weight of the interlining fabric may be reduced by approximately half.

Advantageously, the flame-resistant interlining fabric is one in which the sheep wool fibers have a fiber fineness of 15 to 30 m₈₂ and a staple length of 30 to 51 mm, and the synthetic, flame-retardant fibers have a fiber titer of 1.2 to 3.5 dtex and a staple length of 20 to 120 mm. The fiber finenesses and staple lengths according to the present invention permit a very uniform distribution of fibers and yield a flame-resistant interlining fabric whose mechanical strength factors result in the required dimensional stabilities accompanied by significantly reduced weights per unit area, even without additional reinforcement using a woven fabric.

The synthetic, flame-retardant fibers advantageously are made of meta-aramide fibers, para-aramide fibers, melamine resin fibers, polyamidimide fibers, polyimide fibers, polybenzimidazole fibers and/or preox fibers. Preferably, however, mixtures of para-aramide fibers and melamine resin fibers or polyamidimide fibers are used as synthetic, flame-retardant fibers. Preferably, fibers made of combed merino wool are used as wool fibers. The fiber fineness and staple length of these fibers allow for the manufacture of flame-resistant interlining fabrics according to the present invention having a low weight per unit area, very good haptic properties and the required dimensional stability. For additional improvement of the flame-retardant properties, the sheep wool fibers may be impregnated using a flame-retardant agent such as potassium hexafluoro zirconate (K₂ZrF₆).

The flame-resistant interlining fabrics according to the present invention are manufactured in such a way that the fibers are homogeneously mixed and processed into card webs in a carding machine, bonded by treatment on at least one side in a high-pressure fluid jet facility at pressures of 20 to 235 bar and subsequently dried at temperatures of 190 to 215° C.

According to the present invention, the flame-resistant interlining fabrics are used as stabilizing fabrics for moisture barriers and/or at least a two-ply quilted composite with lining materials.

The invention is illustrated below in terms of two examples:

### EXAMPLE 1

30 wt. % combed merino wool having a staple length of 50 to 75 mm and a fiber fineness of 17 to 25 mp is homogeneously mixed with 35 wt. % melamine resin fibers having a fiber titer of 2.2 dtex and a staple length of 50 mm, as well as 35 wt. % para-aramide fibers having a fiber titer of 1.7 dtex and a staple length of 40 mm and processed into card webs in a carding machine. The bonding is carried out in a water jet facility at pressures of 130 to 235 bar. The flame-resistant interlining fabrics obtained have a weight per unit area of 55 to 65 g/m² and yield a TPP value of 35 at a thickness of 0.95 mm. The moisture absorption capacity is 13%.

### EXAMPLE 2

A mixture of 40 wt. % combed merino wool having a staple length of 45 to 70 mm and a fiber fineness of 17 to 25 m and 60 wt. % polyamidimide fibers having a staple length of 60 mm and a fiber titer of 2.2 dtex is processed, as in Example 1, to form a flame-resistant interlining fabric having a weight per unit area of 60 to 90 g/m² and yields TPP values of 34 to 42 at thicknesses of 0.9 to 1.3 mm and a moisture absorption capacity of about 19%.

1-9. (canceled)

10. A flame-resistant interlining fabric for protective clothing comprising:
a nonwoven fabric bonded by high-pressure fluid-jet treatment, wherein the nonwoven fabric contains 20 to 50 wt. % of a sheep wool fiber and 50 to 80 wt. % of at least one synthetic, flame-retardant fiber, and wherein the flame-resistant interlining fabric has a weight per unit area of 40 to 200 g/m².

11. The flame-resistant interlining fabric of claim 10, wherein the flame-resistant interlining fabric has a weight per unit area of 50 to 100 g/m².

12. The flame-resistant interlining fabric of claim 10, wherein the sheep wool fiber has a fiber fineness of 15 to 30 m_{μ} and a staple length of 30 to 150 mm, and wherein the at least one synthetic, flame-retardant fiber has a fiber titer of 1.2 to 3.5 dtex and a staple length of 20 to 120 mm.

13. The flame-resistant interlining fabric of claim 11, wherein the sheep wool fiber has a fiber fineness of 15 to 30 mp and a staple length of 30 to 150 mm, and wherein the at least one synthetic, flame-retardant fiber has a fiber titer of 1.2 to 3.5 dtex and a staple length of 20 to 120 mm.

14. The flame-resistant interlining fabric of claim 10, wherein the at least one synthetic, flame-retardant fiber comprises a member selected from the group consisting of a meta-aramide fiber, a para-aramide fiber, a melamine resin fiber, a polyamidimide fiber, a polyimide fiber, a polybenzimidazole fiber, a preox fiber, and combinations thereof.

15. The flame-resistant interlining fabric of claim 14, wherein the at least one synthetic, flame-retardant fiber comprises a member selected from the group consisting of a combination of a para-aramide fiber and a melamine resin fiber, and a combination of a para-aramide fiber and a polyamidimide fiber.

16. The flame-resistant interlining fabric of claim 10, wherein the sheep wool fiber comprises a combed merino wool.

17. The flame-resistant interlining fabric of claim 10, wherein the sheep wool fiber is impregnated with a flame-retardant agent.

18. The flame-resistant interlining fabric of claim 16, wherein the sheep wool fiber is impregnated with a flame-retardant agent.

19. The flame-resistant interlining fabric of claim 10, wherein the flame-resistant interlining fabric has a moisture absorption capacity of 13% to about 19%.

20. A method for manufacturing a flame-resistant interlining fabric, the method comprising:
homogeneously mixing the fibers of a nonwoven fabric containing 20 to 50 wt. % of a sheep wool fiber and 50 to 80 wt. % of at least one synthetic, flame-retardant fiber;
processing the homogeneously mixed fibers into card webs using a carding machine;
bonding the processed fibers by a treatment on at least one side thereof in a high-pressure fluid-jet facility at pressures of 20 to 235 bar; and
drying the bonded fibers at temperatures in the range of 190 to 215° C. to form the flame-resistant interlining fabric;
wherein the flame-resistant interlining fabric has a weight per unit area of 40 to 200 g/m².

21. The method of claim 20, wherein the flame-resistant interlining fabric has a weight per unit area of 50 to 100 g/m².

22. The method of claim 20, wherein the sheep wool fiber has a fiber fineness of 15 to 30 mp and a staple length of 30 to 150 mm, and wherein the at least one synthetic, flame-retardant fiber has a fiber titer of 1.2 to 3.5 dtex and a staple length of 20 to 120 mm.

23. The method of claim 21, wherein the sheep wool fiber has a fiber fineness of 15 to 30 m_{μ} and a staple length of 30 to 150 mm, and wherein the at least one synthetic, flame-retardant fiber has a fiber titer of 1.2 to 3.5 dtex and a staple length of 20 to 120 mm.

24. The method of claim 20, wherein the at least one synthetic, flame-retardant fiber comprises a member selected from the group consisting of a meta-aramide fiber, a para-aramide fiber, a melamine resin fiber, a polyamidimide fiber, a polyimide fiber, a polybenzimidazole fiber, a preox fiber, and combinations thereof.

25. The method of claim 24, wherein the at least one synthetic, flame-retardant fiber comprises a member selected from the group consisting of a combination of a para-aramide fiber and a melamine resin fiber, and a combination of a para-aramide fiber and a polyamidimide fiber.

26. The method of claim 20, wherein the sheep wool fiber comprises a combed merino wool.

27. The method of claim 20, wherein the sheep wool fiber is impregnated with a flame-retardant agent.

28. The method of claim 26, wherein the sheep wool fiber is impregnated with a flame-retardant agent.

29. A quilted composite comprising:
a two-ply flame-resistant interlining fabric for protective clothing comprising:
a nonwoven fabric bonded by high-pressure fluid-jet treatment, wherein the nonwoven fabric contains 20 to 50 wt. % of a sheep wool fiber and 50 to 80 wt. % of at least one synthetic, flame-retardant fiber, and wherein the flame-resistant interlining fabric has a weight per unit area of 40 to 200 g/m²; and a lining material.
